(19) United States
(12) Patent Application Publication
(10) Pub. No.: US 2009/0307384 A1
(43) Pub. Date: Dec. 10, 2009

(54) USB PORT TESTING APPARATUS AND METHOD

(75) Inventor: GUO-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/237,227

(22) Filed: Sep. 24, 2008

(30) Foreign Application Priority Data
Jun. 5, 2008 (CN) 200810302043.X

(51) Int. Cl. G06F 3/00

(52) U.S. Cl. 710/19

(57) ABSTRACT

A USB port testing method is used for testing a USB port of an electronic device. The USB port is connected to a USB device. The electronic device includes a USB controller connected to the USB port. The method includes following steps: reading USB bus information from the USB controller and information from the USB device; and judging the work status of the USB port by analyzing the USB bus information and information from the USB device.

### BACKGROUND

1. Technical Field

The present invention relates to a testing apparatus and method for testing USB ports.

2. Description of Related Art

Today, universal serial bus (USB) technology is broadly applied to serial communication solutions and has become more and more important. Before distributing electronic devices having USB ports to the market, the USB ports need to be tested. A typical method for testing the USB ports is using typical USB devices such as USB mice, keyboards, and hard disk drives, directly connected to the USB ports, and inspecting the working status of the USB devices to determine if the USB ports meet the requirements of the electronic devices. However, the method includes identifying the types of the USB devices, loading drivers of the USB devices, and identifying the types of files from the USB devices, which is time consuming.

Therefore, a testing apparatus and method for testing USB ports is desired to overcome the above described deficiency.

### BRIEF DESCRIPTION OF THE DRAWINGS

FIG. 1 is a schematic view of an embodiment of a USB port testing apparatus; and

FIG. 2 is a flowchart of an embodiment of a USB port testing method.

### DETAILED DESCRIPTION OF THE EMBODIMENTS

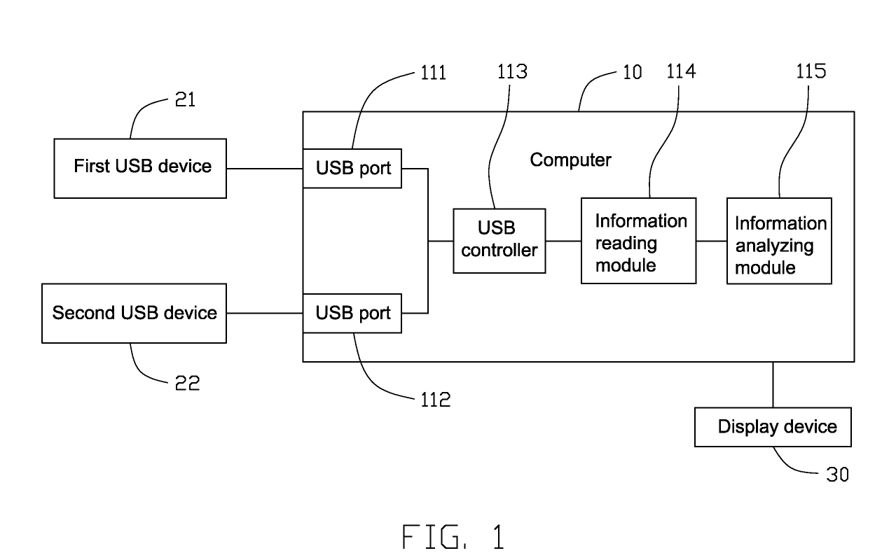

Referring to FIG. 1, a USB testing apparatus includes an electronic device to be tested and a display device 30. In the embodiment of FIG. 1, the electronic device is a computer 10.

The computer 10 includes two USB ports 111, 112, a USB controller 113, an information reading module 114, and an information analyzing module 115. The USB port 111 is connected to a first USB device 21, and the USB port 112 is connected to a second USB device 22. The USB controller 113 is connected to the USB ports 111, 112.

The information reading module 114 is configured to read USB bus configuration information from the USB controller 113, and configuration information from the first USB device 21 and the second USB device 22. USB bus configuration information includes port numbers and bus numbers. Each of the USB ports 111, 112 corresponds to a port number and a bus number.

The information analyzing module 115 is configured to analyze the operating status of the USB ports 111, 112 according to information read by the information reading module 114, and transfer the information to the display device 30.

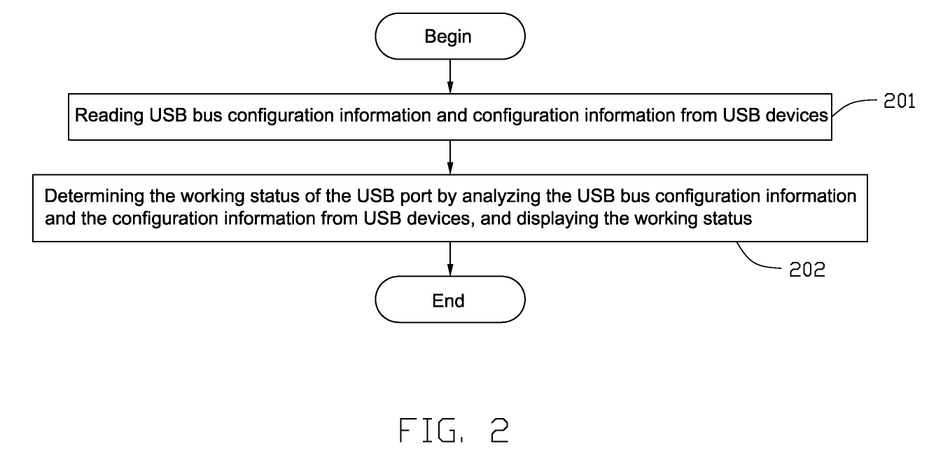

FIG. 2 illustrates a USB port testing method. Depending on the embodiment, certain of the steps described below may be removed, others may be added, and the sequence of steps may be altered.

In a step S201, the information reading module 114 reads USB bus configuration information from the USB controller 113 and configuration information from the USB devices 21, 22.

Continuing to a step S202, the information analyzing module 115 analyzes the working status of the USB ports 111, 112 according to information read by the information reading module 114. If the information reading module 114 reads USB bus configuration information and configuration information from the USB device 21 successfully, the USB port 111 is in a good working status. If the information reading module 114 reads the USB bus configuration information and configuration information from the USB device 21 unsuccessfully, the USB port 111 is in a defective working status. The USB port 112 is tested at the same time from the USB device 22. The working status is displayed via the display device 30.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A USB port testing method for testing a USB port of an electronic device, the USB port being connected to a USB device, the electronic device comprising a USB controller connected to the USB port, the method comprising:
reading USB bus configuration information from the USB controller and configuration information from the USB device; and
determining a working status of the USB port by analyzing the USB bus information and the information from the USB device.

2. The method of claim 1, wherein the working status is defective if the USB bus configuration information and the configuration information from the USB device are read unsuccessfully.

3. The USB port testing method of claim 1, wherein the working status is good if the USB bus configuration information and the configuration information from the USB device are read successfully.

4. The USB port testing method of claim 1, further comprising displaying the working status via a display device.

5. The USB port testing method of claim 1, wherein the electronic device is a computer.

6. A USB port testing apparatus comprising a USB device;
an electronic device having a USB port connected to the USB device; and
a USB controller connecting the USB port, wherein the electronic device comprises:
an information reading module configured to read USB bus configuration information from the USB controller and configuration information from the USB device; and
an information analyzing module configured to determine a working status of the USB port by analyzing the USB bus configuration information and the configuration information from the USB device.

7. The USB port testing apparatus of claim 6, wherein the working status is defective if the USB bus configuration information and the configuration information from the USB device are read unsuccessfully.

8. The USB port testing apparatus of claim 6, wherein the working status is good if the USB bus configuration information and the configuration information from the USB device are read successfully.

9. The USB port testing apparatus of claim 6, further comprising a display device configured to display the working status from the information analyzing module.

10. The USB port testing apparatus of claim 6, wherein the electronic device is a computer.
